(19) United States
(12) Patent Application Publication
(10) Pub. No.: US 2026/0184314 A1
(43) Pub. Date: Jul. 2, 2026

(54) ELECTRIC VEHICLE HAVING LUBRICATION FLUID PASSAGE PROVIDED IN PLANETARY GEAR DEVICE

(71) Applicant: TOYOTA JIDOSHA KABUSHIKI KAISHA, Toyota-shi (JP)

(72) Inventors: Tsukasa SAKAMAKI, Toyota-shi (JP); Hiroshi TAMURA, Toyota-shi (JP); Yuki KATAYAMA, Toyota-shi (JP)

(73) Assignee: TOYOTA JIDOSHA KABUSHIKI KAISHA, Toyota-shi (JP)

(21) Appl. No.: 19/432,114

(22) Filed: Dec. 24, 2025

(30) Foreign Application Priority Data
Dec. 27, 2024 (JP) 2024-232640

(51) Int. Cl. B60W 30/184; B60W 10/02; B60W 10/08; B60W 10/30; F16H 57/04

(52) U.S. Cl. CPC B60W 30/184; B60W 10/02; B60W 10/08; B60W 10/30; F16H 57/043; F16H 57/0435; F16H 57/0436; F16H 57/0471; B60W 2510/30; B60W 2520/10; B60W 2710/021; B60W 2710/08; B60W 2710/305

(57) ABSTRACT

An electric vehicle including an electric motor, a planetary gear device configured to transmit a power of the electric motor toward drive wheels, and a lubrication fluid passage provided in a pinion shaft of the planetary gear device. When a running state is a motor-driving requiring state, the electric motor is driven with a power transmission path between the planetary gear device and the drive wheels being connected, and a lubricating operation is performed for lubricating a component requiring to be lubricated. When the running state is a motor-driving non-requiring state, the electric motor is stopped with the power transmission path being disconnected. When the running state is in a transition from the motor-driving non-requiring state to the motor-driving requiring state, the electric motor is driven and the lubricating operation is performed with the power transmission path being held disconnected.

This application claims priority from Japanese Patent Application No. 2024-232640 filed on Dec. 27, 2024, the disclosure of which is herein incorporated by reference in its entirety.

### FIELD OF THE INVENTION

The present invention relates to an electric vehicle having a lubrication oil passage provided in a pinion shaft of a planetary gear device that transmits a power from an electric motor to drive wheels.

### BACKGROUND OF THE INVENTION

There is well known a drive unit including an electric motor; a planetary gear device configured to transmit a power of the electric motor toward drive wheels; an electric fluid pump configured to discharge a fluid; and a lubrication fluid passage. For example, a vehicle drive apparatus is described in Patent Document 1. Patent Document 1 illustrates a lubrication oil passage provided in a pinion shaft of the planetary gear device. The lubrication oil passage includes an axially extending portion extending in an axial direction of the pinion shaft, and a radially extending portion connected to the axially extending portion and extending in a radial direction of the pinion shaft. An oil discharged from the electric oil pump is introduced into the axially extending portion, and an oil introduced into the axially extending portion is supplied through the radially extending portion to a component that requires to be lubricated. The part that requires to be lubricated is, for example, a needle bearing that is provided between the pinion shaft and pinions that are supported by the pinion shaft so as to be rotatable about their axes. Patent Document 1 teaches that the vehicle drive apparatus may be installed in a hybrid vehicle, i.e., an electric vehicle, and that the electric vehicle may be equipped with a controller, i.e., a control apparatus.

### PRIOR ART DOCUMENT

### Patent Document

[patent Document 1]

Japanese Patent Application Laid-Open 2024-25399

### SUMMARY OF THE INVENTION

By the way, it might be possible to provide a disconnection mechanism configured to connect and disconnect a power transmission path between the planetary gear device and the drive wheels. When a running state of the electric vehicle does not require the electric motor to be driven, the electric motor is stopped and the disconnection mechanism is placed in a disconnected state, thereby disconnecting the power transmission path. This avoids the pinion shaft from being rotated and centrifugal force from acting on the lubrication oil passage. In this state, the oil does not reach the component that requires to be lubricated, leaving the component in a poorly lubricated state. When the running state of the electric vehicle requires the electric motor to be driven and the power from the electric motor is transmitted to the planetary gear device, a load is inputted to the component that requires to be lubricated while it remain in the poorly lubricated state, which could reduce durability of the component.

The present invention was made against background of the above circumstances, and its purpose is to provide an electric vehicle in which reduction of durability of a component that requires to be lubricated can be suppressed.

According to the present invention, there is provided an electric vehicle including: (a) drive wheels; (b) a drive unit including (b-1) an electric motor, (b-2) a planetary gear device configured to transmit a power of the electric motor toward the drive wheels, (b-3) an electric fluid pump configured to discharge a fluid, (b-4) a lubrication fluid passage provided in a pinion shaft of the planetary gear device and (b-5) a component that requires to be lubricated, such that the fluid discharged by the electric fluid pump is supplied to the component through the lubrication fluid passage; and (c) a control apparatus. The drive unit further includes (b-6) a disconnection mechanism which is provided in a power transmission path between the planetary gear device and the drive wheels and which is configured to connect and disconnect the power transmission path. The control apparatus is configured to determine whether a running state of the electric vehicle is a motor-driving requiring state requiring the electric motor to be driven. When determining that the running state is the motor-driving requiring state, the control apparatus is configured to drive the electric motor and to place the disconnection mechanism into a connecting state for connecting the power transmission path, and is configured to perform a lubricating operation for lubricating the component by drive of the electric fluid pump and rotation of the pinion shaft. When determining that the running state is a motor-driving non-requiring state not requiring the electric motor to be driven, the control apparatus is configured to stop driving the electric motor and to place the disconnection mechanism into a disconnecting state for disconnecting the power transmission path. When having determined that the running state is the motor-driving non-requiring state, the control apparatus is configured to determine whether the running state is in a transition from the motor-driving non-requiring state to the motor-driving requiring state. When determining that the running state is in the transition from the motor-driving non-requiring state to the motor-driving requiring state, the control apparatus is configured to drive the electric motor and perform the lubricating operation while maintaining the disconnecting state of the disconnection mechanism.

In the control apparatus according to the present invention, when the running state of the electric vehicle is not a motor-driving requiring state, namely, when the running state of the electric vehicle is the above-described motor-driving non-requiring state, the electric motor is stopped and the disconnection mechanism is placed in the disconnected state. On the other hand, when the running state of the electric vehicle is in the transition from the motor-driving non-requiring state to the motor-driving requiring state, namely, when the running state is approaching the motor-driving requiring state, the electric motor is driven and the lubricating operation is performed, while the disconnected state of the disconnection mechanism is maintained. This makes it possible to prevent or suppress the component that requires to be lubricated from being placed in a poorly lubricated state when the running state of the electric vehicle is the motor-driving requiring state and the power from the electric motor is transmitted to the planetary gear device, thereby suppressing reduction of the durability of the component that requires to be lubricated.

### BRIEF DESCRIPTION OF THE DRAWINGS

FIG. 1 is a view schematically showing a construction of an electric vehicle to which the present invention is applied, and also main parts of a control system for various controls in the electric vehicle;

FIG. 2 is a cross-sectional view showing, in enlargement, a main part of a front drive device shown in FIG. 1;

FIG. 3 is a flow chart showing a main control operation of an electronic control apparatus, namely, a control routine executed by the electronic control apparatus for preventing reduction of durability of a component that requires to be lubricated, wherein it is determined whether a front-driving requiring state has been approached due to a high running speed of the electric vehicle;

FIGS. 4A-4C are flow charts showing main control operations of the electronic control apparatus, namely, control routines executed by the electronic control apparatus for preventing reduction of durability of the component that requires to be lubricated, wherein FIG. 4A shows the control routine in which it is determined whether the front-driving requiring state has been approached due to a low running speed of the electric vehicle, FIG. 4B shows the control routine in which it is determined whether the front-driving requiring state has been approached due to a drive request amount, and FIG. 4C shows the control routine in which it is determined whether the front-driving requiring state has been approached due to an uphill road, and

FIGS. 5A and 5B are flow charts showing main control operations of the electronic control apparatus, namely, control routines executed by the electronic control apparatus for appropriately performing a preliminary lubrication control even when an oil temperature is low, wherein FIG. 5A shows the control routine for setting a predetermined engagement preparation amount, and FIG. 5B shows the control routine for setting an output of an electric oil pump.

### DETAILED DESCRIPTION OF PREFERRED EMBODIMENT

Hereinafter, an embodiment of the present invention will be described in detail with reference to the drawings.

### Embodiment

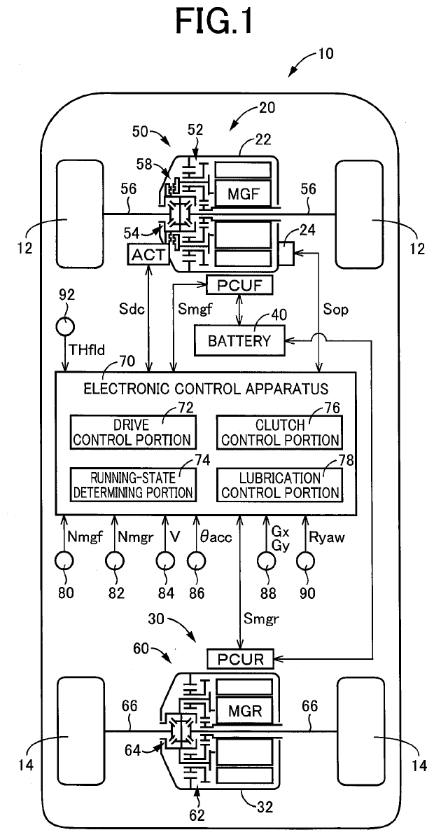

FIG. 1 is a view schematically showing a construction of an electric vehicle 10 to which the present invention is applied, and also main parts of a control system for various controls in the electric vehicle 10. As shown in FIG. 1, the electric vehicle 10 includes front wheels 12, a front drive device 20 that drives the front wheels 12, rear wheels 14 and a rear drive device 30 that drives the rear wheels 14, all of which are spaced apart from one another. The electric vehicle 10 further includes a battery 40, which is a chargeable and dischargeable DC power source. The front wheels 12 and rear wheels 14 are both drive wheels.

The front drive device 20 includes a front casing 22, a front power transmission device 50, a front electric motor MGF and a front electric-power control device PCUF. The front casing 22 is a casing that is attached to a vehicle body (i.e., a body of the electric vehicle 10).

The front electric motor MGF is provided in the front casing 22. The front electric motor MGF is a known rotating electric machine, a so-called motor generator, and is connected to the battery 40 through the front electric-power control device PCUF. The front electric-power control device PCUF is equipped with, for example, an inverter, and controls an electric power exchanged between the battery 40 and the front electric motor MGF. The front electric-power control device PCUF is controlled by an electronic control apparatus 70, which will be described later, so as to control a front electric motor torque Tmgf, which is a torque of the front electric motor MGF.

The front power transmission device 50 includes a front planetary gear device 52 and a front differential gear device 54 that are provided within the front casing 22. The front power transmission device 50 also includes a pair of front drive shafts 56 connected to the front differential gear device 54. The front planetary gear device 52 has an input portion connected to the front electric motor MGF in a power transmittable manner, and an output portion connected to the front differential gear device 54 in a power transmittable manner. The front drive shafts 56 connect the front differential gear device 54 to the front wheels 12. The front power transmission device 50 transmits a power from the front electric motor MGF to the front wheels 12.

The rear drive device 30 includes a rear casing 32, a rear power transmission device 60, a rear electric motor MGR and a rear electric-power control device PCUR. The rear casing 32 is a casing that is attached to the vehicle body.

The rear electric motor MGR is provided in the rear casing 32. The rear electric motor MGR is a known rotating electric machine, a so-called motor generator, and is connected to the battery 40 through the rear electric-power control device PCUR. The rear electric-power control device PCUR has the same function as the front electric-power control device PCUF, and is controlled by the electronic control apparatus 70, so as to control a rear electric motor torque Tmgr, which is a torque of the rear electric motor MGR.

Similarly to the front power transmission device 50, the rear power transmission device 60 includes a rear planetary gear device 62, a rear differential gear device 64 and a pair of rear drive shafts 66. The rear power transmission device 60 transmits a power from the rear electric motor MGR toward the rear wheels 14.

The front power transmission device 50 includes a dog clutch 58 and an actuator ACT. The dog clutch 58 is a known mesh-type clutch provided in the power transmission path between the front planetary gear device 52 and the front wheels 12. The actuator ACT is controlled by the electronic control apparatus 70 to control switching of the dog clutch 58 between an engaged state and a released state.

The electric vehicle 10 is an all-wheel drive vehicle that can adjust distribution of drive torque between the front wheels 12 and the rear wheels 14. The all-wheel drive (AWD) and four-wheel drive (4WD) are synonymous. In addition to running under 4WD control (also synonymous with 4WD state), the electric vehicle 10 can also run under two-wheel drive (2WD) control (also synonymous with 2WD state) in which the drive torque is distributed only to the rear wheels 14. The 4WD state is a driving state in which the dog clutch 58 is in the engaged state for driving the front wheels 12 and the rear wheels 14, and the power transmission path between the front wheels 12 and the front electric motor MGF is connected. The 2WD state is a driving state in which the dog clutch 58 is in the released state for driving only the rear wheels 14, and the power transmission path between the front wheels 12 and the front electric motor MGF is disconnected. By disconnecting the power transmission path between the front wheels 12 and the front electric motor MGF during the 2WD control, it is possible to avoid the front planetary gear device 52 and the front electric motor MGF from being dragged by the front wheel 12, during the 2WD control, thereby suppressing losses due to drag from the front wheels 12 and improving electricity efficiency. The dog clutch 58 is configured to connect and disconnect the power transmission path between the front planetary gear device 52 and the front wheels 12, and corresponds to “disconnection mechanism” recited in the appended claims. Unless otherwise specified, the 4WD state of the electric vehicle 10 and the engaged state of the dog clutch 58 are synonymous, and the 2WD state of the electric vehicle 10 and the released state of the dog clutch 58 are synonymous.

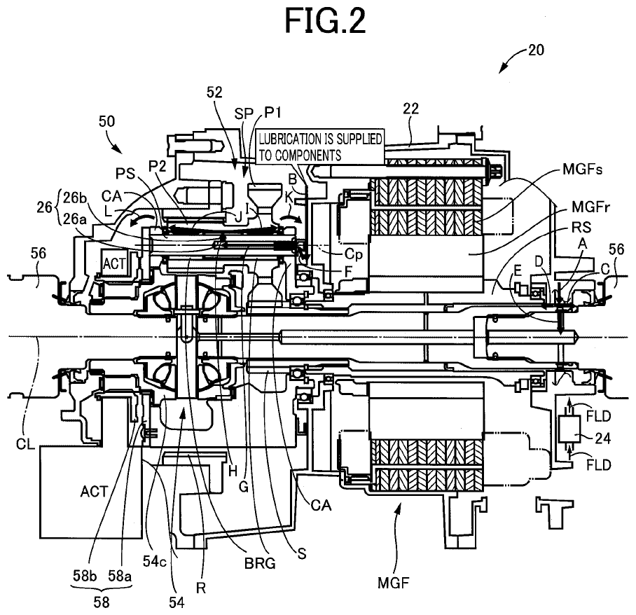

FIG. 2 is a cross-sectional view showing, in enlargement, a main part of a front drive device 20.

As shown in FIG. 2, the front electric motor MGF is rotatable around a rotation axis CL. The front electric motor MGF is equipped with a stator MGFs fixed non-rotatably to the front casing 22, a rotor MGFr located on an inner peripheral side of the stator MGFs, and a rotor shaft RS integrally fixed in an inner circumferential surface of the rotor MGFr. The front differential gear device 54 and the front drive shafts 56 are rotatable around the rotation axis CL.

The front planetary gear device 52 is rotatable around the rotation axis CL. The front planetary gear device 52 includes a sun gear S, stepped pinion sets SP, a carrier CA and a ring gear R. The sun gear S is connected to the rotor shaft RS so as to unrotatable relative to the rotor shaft RS, and is rotatable around the rotation axis CL. The carrier CA is rotatable around the rotation axis CL, and supports the stepped pinion sets SP such that each of the stepped pinion sets SP can be revolved around the rotation axis CL.

Each of the stepped pinion sets SP includes a pinion shaft PS, a large-diameter pinion P1, a small-diameter pinion P2 and a needle bearing BRG. The pinion shaft PS is formed in a cylindrical shape extending longitudinally in a direction of a rotation center Cp. Both axially opposite end portions of the pinion shaft PS are fixed to a pair of carriers CA formed in a disk shape. The large-diameter pinion P1 and the small-diameter pinion P2 are integrally connected. The large-diameter pinion P1 and the small-diameter pinion P2 are mounted on the pinion shaft PS, and are supported rotatably around the rotation center Cp. The large-diameter pinion P1 is a gear that meshes with the sun gear S. The small-diameter pinion P2 is a gear that meshes with the ring gear R. The needle bearing BRG includes a portion located between the pinion shaft PS and the large-diameter pinion P1, and another portion located between the pinion shaft PS and the small-diameter pinion P2.

The ring gear R is a gear that is connected to the sun gear S through the stepped pinion sets SP. The ring gear R is an annular gear with internal teeth which are formed on its inner circumferential surface and which mesh with the small-diameter pinion P2. An outer periphery of the ring gear R is fixed to the front casing 22, so as to be unrotatable. The front planetary gear device 52, which is constructed as described above, is a reduction gear that transmits rotation of the front electric motor MGF to the front differential gear device 54 while reducing a speed of the rotation.

The dog clutch 58 and actuator ACT are disposed on one of opposite sides of the front planetary gear device 52, which is remote from the front electric motor MGF in the direction of the rotation axis CL. The dog clutch 58 has first dog teeth 58a and second dog teeth 58b as opposing meshing teeth. The first dog teeth 58a are connected to one of the carriers CA that is fixed to one of the axially opposite end portions of the pinion shaft PS, which is remote from the front electric motor MGF, so as to be unrotatable relative to the carriers CA. The second dog teeth 58b are connected to a front differential casing 54c that is an input rotary member of the front differential gear device 54 so as to unrotatable relative to the front differential casing 54c. The dog clutch 58 is placed in an engaged state when the first dog teeth 58a and the second dog teeth 58b mesh with each other, by operation of the actuator ACT, and is placed in a released state when the meshing between them is released.

The front drive device 20 further includes an electric oil pump 24 configured to discharge the oil FLD that has been drawn into the electric oil pump 24. The electric oil pump 24 discharges the oil FLD, which has been drawn from an oil reservoir (not shown) that is provided, for example, in a bottom of the front casing 22 and that collects the oil FLD. The oil FLD that is discharged from the electric oil pump 24 is supplied into the front casing 22 (see arrows A and B in FIG. 2). The oil FLD that is supplied into the front casing 22 is used to lubricate various parts of the front power transmission device 50 (see arrows C, D, E, F, K, L in FIG. 2). It is noted that the oil FLD and the electric oil pump 24 correspond to “fluid” and “electric fluid pump”, respectively, which are recited in the appended claims.

The front drive device 20 further includes a lubrication oil passage 26 provided in the pinion shaft PS of the front planetary gear device 52. The lubrication oil passage 26 includes an axially extending portion 26a and a radially extending portion 26b. The axially extending portion 26a is provided in the pinion shaft PS, and extends in the axial direction of the pinion shaft PS, i.e., in the direction of the rotation center Cp. The axially extending portion 26a is a fluid passage portion into which the oil FLD discharged from the electric oil pump 24 is to be introduced. The radially extending portion 26b is provided in the pinion shaft PS that is connected to the axially extending portion 26a, and extends in a radial direction of the pinion shaft PS. The radially extending portion 26b is another fluid passage portion through which the oil FLD that comes out from the radially extending portion 26b is to flow. The oil FLD is supplied to the needle bearing BRG (see arrows G, H, I, J in FIG. 2). The needle bearing BRG corresponds to “component (that requires to be lubricated)” recited in the appended claims.

The front electric motor MGF corresponds to “electric motor” recited in the appended claims. The front planetary gear device 52 is configured to transmit the power from the front electric motor MGF toward the front wheels 12, and corresponds to “planetary gear device” recited in the appended claims. The front drive device 20 corresponds to “drive unit” recited in the appended claims, and includes the front electric motor MGF, the front planetary gear device 52, the electric oil pump 24, the lubrication oil passage 26 and the needle bearing BRG. The front drive device 20 further includes the dog clutch 58.

The rear drive device 30 does not include a disconnection mechanism such as a dog clutch 58, but other components are similar to those of the front drive device 20. For example, the rear drive device 30 includes an electric oil pump and a lubrication oil passage (not shown).

Referring back to FIG. 1, the electric vehicle 10 further includes the electronic control apparatus 70 as a controller. The electronic control apparatus 70 includes a so-called microcomputer equipped with CPU, RAM, ROM, an input/output interface, for example. The CPU executes various controls of the electric vehicle 10 by utilizing the temporary storage function of the RAM and performing signal processing in accordance with programs previously stored in the ROM. The electronic control apparatus 70 corresponds to “control apparatus” recited in the appended claims.

The electronic control apparatus 70 is supplied with various signals based on values detected by various sensors provided in the electric vehicle 10. The various sensors include a front-electric-motor rotational speed sensor 80, a rear-electric-motor rotational speed sensor 82, a running speed sensor 84, an accelerator opening degree sensor 86, a G sensor 88, a yaw rate sensor 90 and an oil temperature sensor 92. The various signals include signals indicative of a front-electric-motor rotational speed Nmgf, a rear-electric-motor rotational speed Nmgr, a running speed V, an accelerator opening degree θacc, a longitudinal acceleration Gx, a lateral acceleration Gy, a yaw rate Ryuw and an oil temperature THfld. The oil temperature THfld is a temperature of the oil FLD drawn in the electric oil pump 24.

Various command signals are outputted from the electronic control apparatus 70 to devices provided in electric vehicle 10. These devices include the above-described front electric-power control device PCUF, rear electric-power control device PCUR, electric oil pump 24 and actuator ACT. The various command signals include a front electric motor control command signal Smgf, a rear electric motor control command signal Smgr, a pump control command signal Sop and a clutch control command signal Sdc. The pump control command signal Sop is a control command signal for controlling output of the electric oil pump 24. The clutch control command signal Sdc is a control command signal for controlling switching of the dog clutch 58 between the engaged state and the released state.

The electronic control apparatus 70 includes a drive control portion 72, a running-state determining portion 74, a clutch control portion 76 and a lubrication control portion 78 to realize various controls in the electric vehicle 10.

The drive control portion 72 calculates a drive request amount DEM for the electric vehicle 10, for example, by applying the accelerator opening degree θacc and the running speed V to a predetermined drive request amount map. The drive request amount DEM is, for example, a required driving force as a required value for driving force acting on the wheels (front wheels 12, rear wheels 14). In the 2WD state, the drive control portion 72 controls the rear electric motor torque Tmgr and executes drive control of the rear electric motor MGR to realize the drive request amount DEM. In the 4WD state, the drive control portion 72 controls the rear electric motor MGR and also controls the front electric motor torque Tmgf and executes drive control of the front electric motor MGF to realize the drive request amount DEM. It is noted that, unless otherwise specified, the torque and the force (driving force) are synonymous.

The running-state determining portion 74 determines whether to switch the driving state of the electric vehicle 10, based on the running speed V, the drive request amount DEM, the longitudinal acceleration Gx, the lateral acceleration Gy and the yaw rate Ryaw, for example. The switching of the driving state is a switching between the 2WD and 4WD states. In the 4WD state, the running state of the electric vehicle 10 is a motor-driving requiring state that requires the front electric motor MGF as the electric motor to be controlled and driven, and is a front-driving requiring state that requires the front electric motor MGF be controlled and driven. The running-state determining portion 74 determines whether the running state of electric vehicle 10 is the front-driving requiring state. Hereinafter, unless otherwise required, the “running state” refers to the “running state of electric vehicle 10.”

The running-state determining portion 74 determines whether the running state is the front-driving requiring state, for example, based on whether the running speed V is equal to or higher than a predetermined first speed value VH, which defines a high running speed range. The running-state determining portion 74 determines whether the running state is the front-driving requiring state, for example, based on whether the running speed V is equal to or lower than a predetermined third running speed VL, which defines a low running speed range. The running-state determining portion 74 determines whether the running state is the front-driving requiring state, for example, based on whether the drive request amount DEM is equal to or larger than a predetermined first amount DEMH, which defines a high load range.

When the running-state determining portion 74 determines that the running state is the front-driving requiring state, the drive control portion 72 drives the rear electric motor MGR and also drives the front electric motor MGF. When the running-state determining portion 74 determines that the running state is not the front-driving requiring state, the drive control portion 72 drives only the rear electric motor MGR without driving the front electric motor MGF.

The clutch control portion 76 controls switching of the dog clutch 58 between the engaged state and the released state. When the running-state determining portion 74 determines that the running state is the front-driving requiring state, the clutch control portion 76 operates the actuator ACT to place the dog clutch 58 into the engaged state. Placing the dog clutch 58 into the engaged state is synonymous with placing the dog clutch 58 into the connecting state in which the power transmission path between the front planetary gear device 52 and the front wheels 12 is connected. When the running-state determining portion 74 determines that the running state is not the front-driving requiring state, the clutch control portion 76 operates the actuator ACT to place the dog clutch 58 into the released state. Placing the dog clutch 58 into the released state is synonymous with placing the dog clutch 58 into the disconnecting state in which the power transmission path between the front planetary gear device 52 and the front wheels 12 is disconnected.

The electric vehicle 10 is placed in the 4WD mode at a relatively low running speed that is equal to or lower than a predetermined third speed value VL, at a relatively high running speed that is equal to or higher than the predetermined first speed value VH, and at a relatively high load that is equal to or larger than the predetermined first amount DEMH. The electric vehicle 10 is placed in the 2WD mode at a relatively medium running speed that is higher than the predetermined third speed value VL and lower than the predetermined first speed value VH, and at a relatively low load that is smaller than the predetermined first amount DEMH.

The lubrication control portion 78 drives the electric oil pump 24 so as to supply oil FLD into the front casing 22. When the electric vehicle 10 is in the 4WD state, the front planetary gear device 52 and other components are rotated, thereby requiring lubrication by the oil FLD. In the 4WD state, the pinion shaft PS of the front planetary gear device 52 is rotated, and therefore, the oil FLD is supplied to the needle bearing BRG by centrifugal force through the lubrication oil passage 26. The lubrication control portion 78 executes the drive control for driving the electric oil pump 24 in the 4WD state. When the running-state determining portion 74 determines that the running state is the front-driving requiring state, the lubrication control portion 78 performs a lubricating operation Mlub for lubricating the needle bearing BRG by drive control of the electric oil pump 24 and rotational drive of the pinion shaft PS.

When the electric vehicle 10 is in the 2WD state, the front electric motor MGF and rotary members of the front power transmission device 50, which are located on one of opposite sides of the dog clutch 58 that is remote from the actuator ACT, are stopped from being rotated, and therefore lubrication by the oil FLD is not necessarily required. Thus, the lubrication control portion 78 does not perform the lubricating operation Mlub when the electric vehicle 10 is in the 2WD state. The lubrication control portion 78 does not perform the lubricating operation Mlub when the running-state determining portion 74 determines that the running state is not the front-driving requiring state. The lubrication control portion 78 does not perform the lubricating operation Mlub, for example, by stopping the driving of the electric oil pump 24. In the 2WD state, the pinion shaft PS is not driven to be rotated, but the front drive shafts 56 are rotated by the front wheels 12, so that some lubrication may be performed. When the lubrication control portion 78 does not perform the lubricating operation Mlub, the electric oil pump 24 may be controlled with reduced output as compared to when the lubricating operation Mlub is performed.

In the 2WD state in which the dog clutch 58 is in the released state, the needle bearing BRG is in a poorly lubricated state. If a load is inputted while the needle bearing BRG is in the poorly lubricated state when the dog clutch 58 is switched from the released state to the engaged state, this may result in a reduction of durability of the needle bearing BRG.

The electronic control apparatus 70 performs a preliminary lubrication control for lubricating the needle bearing BRG in advance, when the running state of the electric vehicle 10 is approaching a state in which the dog clutch 58 is to be engaged while the electric vehicle 10 is running with the dog clutch 58 being in the released state. This prevents or suppresses the decrease of the durability of the needle bearing BRG due to engagement of the dog clutch 58 in the poorly lubricated state.

The running-state determining portion 74 determines whether the running state is approaching the front-driving requiring state, when having determined that the running state is not the front-driving requiring state.

The running-state determining portion 74 determines whether the running state is approaching the front-driving requiring state, for example, depending on whether the running speed V is equal to or higher than a predetermined second speed value VHp when the running speed V is lower than the predetermined first speed value VH. The predetermined second speed value VHp is a value that is lower than the predetermined first speed value VH by a predetermined engagement preparation amount α. The predetermined engagement preparation amount α is a predetermined lubrication preparation amount for eliminating the poorly lubricated state of the needle bearing BRG, for example, when the running speed V approaches the predetermined first speed value VH.

The running-state determining portion 74 determines whether the running state is approaching the front-driving requiring state, for example, depending on whether the running speed V is equal to or lower than a predetermined fourth speed value VLp when the running speed V exceeds the predetermined third speed value VL. The predetermined fourth speed value VLp is a value that is higher than the predetermined third speed value VL by a predetermined engagement preparation amount β. The predetermined engagement preparation amount β is a predetermined lubrication preparation amount for eliminating the poorly lubricated state of the needle bearing BRG, for example, when the running speed V approaches the predetermined third speed value VL. The predetermined engagement preparation amount β may be the same value as the predetermined engagement preparation amount α, or may be a value different from the predetermined engagement preparation amount α. Each of the predetermined engagement preparation amounts α, β corresponds to “predetermined value” recited in the appended claims.

The running-state determining portion 74 determines whether the running state is approaching the front-driving requiring state depending on whether the drive request amount DEM is equal to or larger than a predetermined second amount DEMHp when the drive request amount DEM is smaller than the predetermined first amount DEMH. The predetermined second amount DEMHp is a value that is lower than the predetermined first amount DEMH by a predetermined engagement preparation amount γ, for example. The predetermined engagement preparation amount γ is a predetermined lubrication preparation amount for eliminating the poorly lubricated state of the needle bearing BRG when the drive request amount DEM approaches the predetermined first amount DEMH, for example. The predetermined engagement preparation amount γ corresponds to “predetermined value” recited in the appended claims.

When the electric vehicle 10 is traveling on an uphill road, it is considered that the running state is more likely to become the front-driving requiring state due to an increase of the drive request amount DEM than when the electric vehicle 10 is traveling on a flat road. The running-state determining portion 74 determines whether the running state is approaching the front-driving requiring state, depending on whether a running road on which the electric vehicle 10 is currently traveling is the uphill road when drive request amount DEM is smaller than predetermined first amount DEMH. The running-state determining portion 74 determines whether the running road on which the electric vehicle 10 is currently traveling is the uphill road, for example, depending on whether it can be determined that a longitudinal acceleration Gx is low relative to the driving force.

When the running-state determining portion 74 determines that the running state is approaching the front-driving requiring state, the drive control portion 72 drives the front electric motor MGF while maintaining the released state of the dog clutch 58.

When the running-state determining portion 74 determines that the running state is approaching the front-driving requiring state, the lubrication control portion 78 performs the lubricating operation Mlub while maintaining the released state of the dog clutch 58. During the lubricating operation Mlub when the running state is approaching the front-driving requiring state, the lubrication control portion 78 controls the drive of the electric oil pump 24 with an increased output as compared to when the vehicle is not in the front-driving requiring state and is not approaching the front-driving requiring state. For example, during the lubricating operation Mlub when the running state is approaching the front-driving requiring state, the lubrication control portion 78 may control the drive of the electric oil pump 24 with the output being substantially the same as when the electric vehicle 10 is in the front-driving requiring state.

If not much time has passed since the end of the previous lubricating operation Mlub when the electric vehicle 10 is approaching the front-driving requiring state, it is assumed that the needle bearing BRG is not in the poorly lubricated state, and so that there is no need to perform the lubricating operation Mlub. By not performing drive control of the front electric motor MGF more than necessary, the electricity efficiency is improved.

When determining that the running state is not the front-driving requiring state, the running-state determining portion 74 determines whether an elapsed time TMpas from the end of the lubricating operation Mlub by the lubrication control portion 78 is equal to or longer than a predetermined length of time TMf, namely, determines whether at least the predetermined length of time TMf has elapsed from the end of the lubricating operation.

When the running-state determining portion 74 determines that the elapsed time TMpas is shorter than the predetermined length of time TMf, the drive control portion 72 stops driving the front electric motor MGF even if it is determined that the running state is approaching the front-driving requiring state. When the running-state determining portion 74 determines that the running state is approaching the front-driving requiring state and the elapsed time TMpas is equal to or longer than the predetermined length of time TMf, the drive control portion 72 drives the front electric motor MGF while maintaining the released state of the dog clutch 58.

When the running-state determining portion 74 determines that the elapsed time TMpas is shorter than the predetermined length of time TMf, the lubrication control portion 78 does not perform the lubricating operation Mlub even if it is determined that the running state is approaching the front-driving requiring state. When the running-state determining portion 74 determines that the running state is approaching the front-driving requiring state and the elapsed time TMpas is equal to or longer than the predetermined length of time TMf, the lubrication control portion 78 performs the lubricating operation Mlub while the dog clutch 58 is in the released state.

When the oil temperature THfld is low, a viscosity of the oil FLD is increased, and a time required to lubricate the needle bearing BRG is increased. Therefore, a duration of the lubricating operation Mlub may be increased and/or the output of the electric oil pump 24 may be increased. These measures also have a secondary effect of making it easier to raise the oil temperature THfld.

When the running-state determining portion 74 determines that the running state is approaching the front-driving requiring state, the lubrication control portion 78 performs the lubricating operation Mlub by increasing the output of the electric oil pump 24 when the oil temperature THfld is low as compared to when the oil temperature THfld is high.

The larger the predetermined engagement preparation amounts α, β and γ, the longer the lubricating operation Mlub is likely to be performed. When the oil temperature THfld is low, the running-state determining portion 74 sets the predetermined engagement preparation amounts α, β and γ to larger values than when the oil temperature THfld is high.

The running-state determining portion 74 determines whether the oil temperature THfld is equal to or lower than a predetermined oil temperature THfldf. The predetermined oil temperature THfldf is a predetermined low oil temperature determination value for determining whether the time required for lubrication of the needle bearing BRG is to be extended, for example.

When the running-state determining portion 74 determines that the oil temperature THfld is equal to or lower than the predetermined oil temperature THfldf, the lubrication control portion 78 increases the output of the electric oil pump 24 in the lubricating operation Mlub as compared to when the running-state determining portion 74 determines that the oil temperature THfld is higher than the predetermined oil temperature THfldf.

When determining that the oil temperature THfld is equal to or lower than the predetermined oil temperature THfldf, the running-state determining portion 74 sets the predetermined engagement preparation amounts α, β and γ to larger values than when running-state determining portion 74 determines that oil temperature THfld is higher than predetermined oil temperature THfldf.

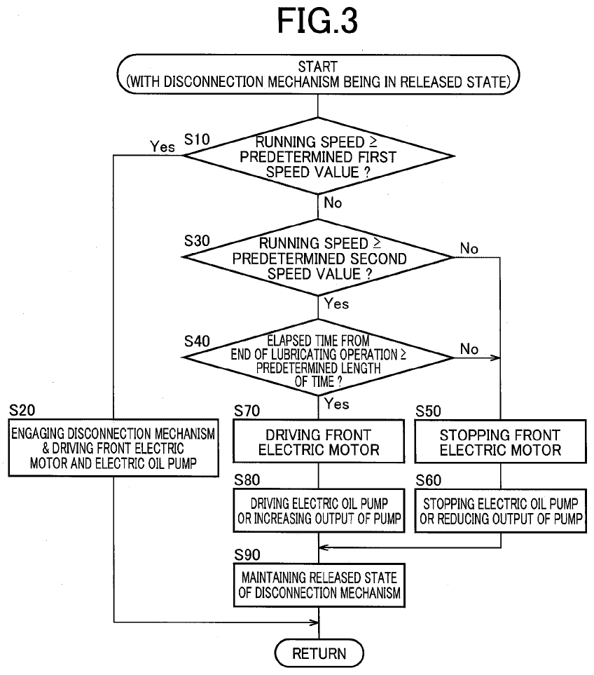

FIG. 3 is a flow chart showing a main control operation of the electronic control apparatus 70, namely, a control routine executed by the electronic control apparatus 70 for preventing reduction of the durability of the component that requires to be lubricated. This control routine is repeatedly executed during running of the electric vehicle 10 with the dog clutch 58 being in the disengaged state, for example. FIG. 3 shows an example in which it is determined whether a high running speed has brought the electric vehicle 10 close to the front-driving requiring state. The disengaged state of the dog clutch 58 is synonymous with the released state of the dog clutch 58.

As shown in FIG. 3, the control routine is initiated with step S10 corresponding to function of the running-state determining portion 74, which is implemented to determine whether the running speed V is equal to or higher than the predetermined first speed value VH. When an affirmative determination is made at step S10, step S10 is followed by step S20 corresponding to functions of the drive control portion 72, clutch control portion 76 and lubrication control portion 78 at which the dog clutch 58 is placed into the engaged state, the front electric motor MGF is driven and the lubricating operation Mlub is performed. When a negative determination is made at step S10, step S30 corresponding to function of the running-state determining portion 74 is implemented to determine whether the running speed V is equal to or higher than the predetermined second speed value VHp. When an affirmative determination is made at step S30, step S40 corresponding to function of the running-state determining portion 74 is implemented to determine whether the elapsed time TMpas from the end of the lubricating operation Mlub is equal to or longer than the predetermined length of time TMf. When a negative determination is made at step S30, and when a negative determination is made at step S40, step S50 corresponding to function of the drive control portion 72 is implemented to stop the drive of the front electric motor MGF. Step S50 is followed by step S60 corresponding to function of the lubrication control portion 78 at which the lubricating operation Mlub is not performed. When an affirmative determination is made at step S40, step S70 corresponding to function of the drive control portion 72 is implemented to drive the front electric motor MGF while maintaining the released state of the dog clutch 58. Step S70 is followed by step S80 corresponding to function of the lubrication control portion 78 at which the lubricating operation Mlub is performed. Steps S60 and S80 are followed by step S90 corresponding to function of the clutch control portion 76 at which the released state of the dog clutch 58 is maintained.

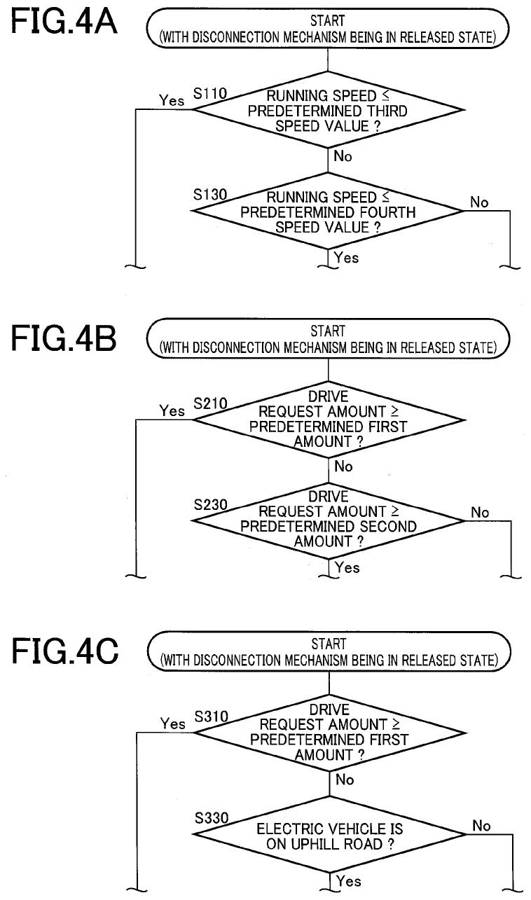

FIGS. 4A-4C are flow charts showing main control operations of the electronic control apparatus 70, namely, control routines executed by the electronic control apparatus 70 for preventing reduction of durability of the component that requires to be lubricated. The control routines are repeatedly executed during running of the electric vehicle 10 with the dog clutch 58 being in the disengaged state, for example. FIG. 4A shows the control routine in which it is determined whether the front-driving requiring state has been approached due to a low running speed of the electric vehicle 10, wherein steps S110 and S130 are implemented in place of steps S10 and S30 of the control routine shown in FIG. 3, and the other steps (not shown in FIG. 4A) are identical with steps S20, S40, S50, S60, S70, S80 and S90 of the control routine shown in FIG. 3. FIG. 4B shows the control routine in which it is determined whether the front-driving requiring state has been approached due to the drive request amount, wherein steps S210 and S230 are implemented in place of steps S10 and S30 of the control routine shown in FIG. 3, and the other steps (not shown in FIG. 4B) are identical with steps S20, S40, S50, S60, S70, S80 and S90 of the control routine shown in FIG. 3. FIG. 4C shows the control routine in which it is determined whether the front-driving requiring state has been approached due to an uphill road, wherein steps S310 and S330 are implemented in place of steps S10 and S30 of the control routine shown in FIG. 3, and the other steps (not shown in FIG. 4C) are identical with steps S20, S40, S50, S60, S70, S80 and S90 of the control routine shown in FIG. 3.

The control flow shown in FIG. 4A is initiated with step S110 corresponding to function of the running-state determining portion 74, which is implemented to determine whether the running speed V is equal to or lower than the predetermined third speed value VL. When an affirmative determination is made at step S110, the control flow goes to step S20 shown in FIG. 3. When a negative determination is made at step S110, step S130 corresponding to function of the running-state determining portion 74 is implemented to determine whether the running speed V is equal to or lower than the predetermined fourth speed value VLp. When an affirmative determination is made at step S130, step S40 shown in FIG. 3 is implemented. When a negative determination is made at step S130, the control flow goes to step S50 shown in FIG. 3.

The control flow shown in FIG. 4B is initiated with step S210 corresponding to function of the running-state determining portion 74, which is implemented to determine whether the drive request amount DEM is equal to or larger than the predetermined first amount DEMH. When an affirmative determination is made at step S210, the control flow goes to step S20 shown in FIG. 3. When a negative determination is made at step S210, step S230 corresponding to function of the running-state determining portion 74 is implemented to determine whether the drive request amount DEM is equal to or larger than the predetermined second amount DEMHp. When an affirmative determination is made at step S230, step S40 shown in FIG. 3 is implemented. When a negative determination is made at step S230, the control flow goes to step S50 shown in FIG. 3.

The control flow shown in FIG. 4C is initiated with step S310 corresponding to function of the running-state determining portion 74, which is implemented to determine whether the drive request amount DEM is equal to or larger than the predetermined first amount DEMH. When an affirmative determination is made at step S310, the control flow goes to step S20 shown in FIG. 3. When a negative determination is made at step S310, step S330 corresponding to function of the running-state determining portion 74 is implemented to determine whether the electric vehicle 10 is on an uphill road. When an affirmative determination is made at step S330, step S40 shown in FIG. 3 is implemented. When a negative determination is made at step S330, the control flow goes to step S50 shown in FIG. 3.

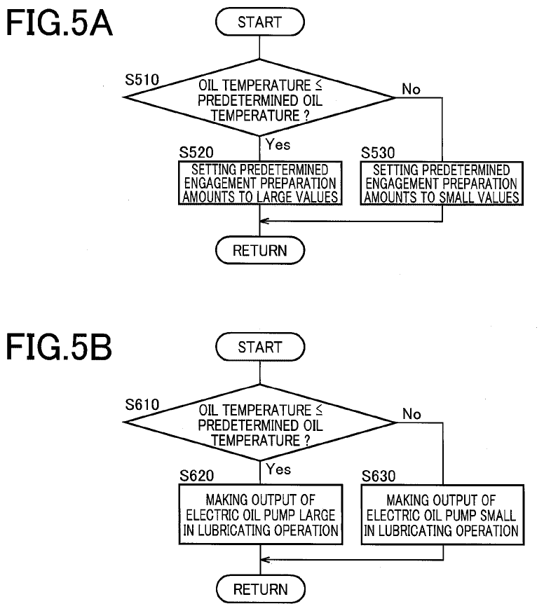

FIGS. 5A and 5B are flow charts showing main control operations of the electronic control apparatus 70, namely, control routines executed by the electronic control apparatus 70 for appropriately performing the preliminary lubrication control even when the oil temperature THfld is low, wherein FIG. 5A shows the control routine for setting the predetermined engagement preparation amounts α, β, γ, and FIG. 5B shows the control routine for setting the output of the electric oil pump 24.

The control flow shown in FIG. 5A is initiated with step S510 corresponding to function of the running-state determining portion 74, which is implemented to determine whether the oil temperature THfld is equal to or lower than the predetermined oil temperature THfldf. When an affirmative determination is made at step S510, step S520 corresponding to function of the running-state determining portion 74 is implemented to set the predetermined engagement preparation amounts α, β, γ to relatively large values. When a negative determination is made at step S510, step S530 corresponding to function of the running-state determining portion 74 is implemented to set the predetermined engagement preparation amounts α, β, γ to relatively small values.

The control flow shown in FIG. 5B is initiated with step S610 corresponding to function of the running-state determining portion 74, which is implemented to determine whether the oil temperature THfld is equal to or lower than the predetermined oil temperature THfldf. When an affirmative determination is made at step S610, step S620 corresponding to function of the lubrication control portion 78 is implemented to make the output of electric oil pump 24 relatively large in the lubricating operation Mlub. When a negative determination is made at step S630, step S630 corresponding to function of the lubrication control portion 78 is implemented to make the output of electric oil pump 24 relatively small in the lubricating operation Mlub.

As described above, in the present embodiment, when the running state of the electric vehicle 10 is not the front-driving requiring state, namely, when the running state of the electric vehicle is a motor-driving non-requiring state not requiring the front electric motor MGF to be driven, the drive of the front electric motor MGF is stopped and the dog clutch 58 is placed in the disconnected state. On the other hand, when the running state is in transition from the motor-driving non-requiring state to the motor-driving requiring state (i.e., front-driving requiring state), namely, when the running state is approaching the front-driving requiring state, the front electric motor MGF is driven and the lubricating operation Mlub is performed, while the disconnected state of the dog clutch 58 is maintained. This makes it possible to prevent or suppress the component that requires to be lubricated from being placed in a poorly lubricated state when the running state of the electric vehicle 10 is the front-driving requiring state and the power from the front electric motor MGF is transmitted to the front planetary gear device 52, thereby suppressing reduction of the durability of the component that requires to be lubricated.

Further, in the present embodiment, when the elapsed time TMpas from the end of the lubricating operation Mlub is shorter than the predetermined length of time TMf, the front electric motor MGF is not driven even if the running state of the electric vehicle 10 is approaching the front-driving requiring state. When the running state is approaching the front-driving requiring state and the elapsed time TMpas is equal to or longer than the predetermined length of time TMf, the front electric motor MGF is driven with the dog clutch 58 being kept in the disconnected state, and the lubricating operation Mlub is performed. This makes it possible to prevent or suppress the drive of the front electric motor MGF from being made more than necessary when the part that requires to be lubricated is lubricated, thereby improving electricity efficiency.

Further, in the present embodiment, when the running state is approaching the front-driving requiring state, the lubricating operation is performed by controlling the output of the electric fluid pump 24 such that the output of the pump 24 is made larger as the oil temperature THfld is lower. This addresses the problem of the time required to lubricate the part that requires to be lubricated being extended when the oil temperature THfld is low.

Further, in the present embodiment, it is determined that the running state of the electric vehicle 10 is the front-driving requiring state when the running speed V is equal to or higher than the predetermined first speed value VH that defines the high running speed range, and it is determined that the running state is approaching the front-driving requiring state, namely, is in the transition from the motor-driving non-requiring state to the motor-driving requiring, when the running speed V is lower than the predetermined first speed value VH and is not lower than the predetermined second speed value VHp that is lower than the predetermined first speed value VH. Alternatively, it is determined that the running state of the electric vehicle 10 is the front-driving requiring state when the running speed V is equal to or lower than the predetermined third speed value VL that defines the low running speed range, and it is determined that the running state is approaching the front-driving requiring state, namely, is in the transition from the motor-driving non-requiring state to the motor-driving requiring, when the running speed V is higher than the predetermined third speed value VL and is not higher than the predetermined fourth speed value VLp that is higher than the predetermined third speed value VL. As a result, when the running speed V is used to determine whether drive of front electric motor MGF is required or not, the part that requires to be lubricated can be appropriately lubricated.

Further, in the present embodiment, when the oil temperature THfld is low, the predetermined engagement preparation amounts α, β, γ are set to larger values than when the oil temperature THfld is high. This makes it possible to address the problem that the time required to lubricate the part that requires to be lubricated is extended when the oil temperature THfld is low.

Further, in the present embodiment, it is determined that the running state of the electric vehicle 10 is the front-driving requiring state when the drive request amount DEM is equal to or larger than the predetermined first amount DEMH, and it is determined that the running state is approaching the front-driving requiring state, namely, is in the transition from the motor-driving non-requiring state to the motor-driving requiring, when the drive request amount DEM is smaller than the predetermined first amount value DEMH and is not smaller than the predetermined second amount value DEMHp that is smaller than the predetermined first amount value DEMH. Alternatively, it is determined that the running state is approaching the front-driving requiring state, namely, is in the transition from the motor-driving non-requiring state to the motor-driving requiring, when the electric vehicle 10 is on an uphill road even if the drive request amount DEM is smaller than the predetermined first amount value DEMH.

Although the embodiment of the present invention has been described in detail above with reference to the drawings, the present invention can also be applied to other embodiments.

For example, in the above-described embodiment, the part requiring lubrication is not limited to the needle bearing BRG. For example, the part requiring lubrication may include other bearings such as a bearing disposed between the large-diameter pinion P1 and the carrier CA to which the end of the pinion shaft PS is fixed and a bearing disposed between the small-diameter pinion P2 and the carrier CA to which the other end of the pinion shaft PS is fixed. The oil FLD is supplied to these bearings through the lubrication oil passage 26, just as to the needle bearing BRG.

Further, in the above-described embodiment, for example, the drive unit (front drive device 20) provided with the disconnection mechanism (dog clutch 58) may be configured to drive the rear wheels 14, and the drive unit (rear drive device 30) not provided with the disconnection mechanism may be configured to drive the front wheels 12. Moreover, for example, an engine may be used as the power source for the drive unit not provided with the disconnection mechanism in addition to or in placed of the electric motor.

Further, in the above-described embodiment, step S40 shown in FIG. 3 does not necessarily need to be provided. Even without implementation of the step S40, a certain effect can be obtained, that is, the reduction of the durability of the part that requires to be lubricated can be suppressed.

Further, in the above-described embodiment, the present invention can be applied even where the dog clutch 58 is provided in the power transmission path between the front planetary gear device 52 and the front wheels 12.

It should be noted that the above is merely one embodiment, and the present invention can be embodied in various forms with various modifications and improvements based on the knowledge of those skilled in the art.

### NOMENCLATURE OF ELEMENTS

10: electric vehicle
12: front wheels (drive wheels)
20: front drive device (drive unit)
24: electric oil pump (electric fluid pump)
26: lubrication oil passage (lubrication fluid passage)
26a: axially extending portion
26b: radially extending portion
52: front planetary gear device
BRG: needle bearing (part that requires to be lubricated)
PS: pinion shaft
58: dog clutch (disconnection mechanism)
70: electronic control apparatus
FLD: oil (fluid)
MGF: front electric motor (electric motor)

What is claimed is:

1. An electric vehicle comprising:
(a) drive wheels;
(b) a drive unit including (b-1) an electric motor, (b-2) a planetary gear device configured to transmit a power of the electric motor toward the drive wheels, (b-3) an electric fluid pump configured to discharge a fluid, (b-4) a lubrication fluid passage provided in a pinion shaft of the planetary gear device and (b-5) a component that requires to be lubricated, such that the fluid discharged by the electric fluid pump is supplied to the component through the lubrication fluid passage; and
(c) a control apparatus,
wherein the drive unit further includes (b-6) a disconnection mechanism which is provided in a power transmission path between the planetary gear device and the drive wheels and which is configured to connect and disconnect the power transmission path,
wherein the control apparatus is configured to determine whether a running state of the electric vehicle is a motor-driving requiring state requiring the electric motor to be driven,
wherein, when determining that the running state is the motor-driving requiring state, the control apparatus is configured to drive the electric motor and to place the disconnection mechanism into a connecting state for connecting the power transmission path, and is configured to perform a lubricating operation for lubricating the component by drive of the electric fluid pump and rotation of the pinion shaft,
wherein, when determining that the running state is a motor-driving non-requiring state not requiring the electric motor to be driven, the control apparatus is configured to stop driving the electric motor and to place the disconnection mechanism into a disconnecting state for disconnecting the power transmission path,
wherein, when having determined that the running state is the motor-driving non-requiring state, the control apparatus is configured to determine whether the running state is in a transition from the motor-driving non-requiring state to the motor-driving requiring state, and
wherein, when determining that the running state is in the transition from the motor-driving non-requiring state to the motor-driving requiring state, the control apparatus is configured to drive the electric motor and perform the lubricating operation while maintaining the disconnecting state of the disconnection mechanism.

2. The electric vehicle according to claim 1,
wherein, when determining that the running state of the electric vehicle is the motor-driving non-requiring state, the control apparatus is configured to determine whether at least a predetermined length of time has elapsed from an end of the lubricating operation,
wherein, when determining that the predetermined length of time has not elapsed from the end of the lubricating operation, the control apparatus is configured not to drive the electric motor, even if determining that the running state is in the transition from the motor-driving non-requiring state to the motor-driving requiring state, and
wherein, when determining that the running state is in the transition from the motor-driving non-requiring state to the motor-driving requiring state, and that the predetermined length of time has elapsed from the end of the lubricating operation, the control apparatus is configured to drive the electric motor and perform the lubricating operation while maintaining the disconnecting state of the disconnection mechanism.

3. The electric vehicle according to claim 1,
wherein, when determining that the running state of the electric vehicle is in the transition from the motor-driving non-requiring state to the motor-driving requiring state, the control apparatus is configured to perform the lubricating operation, by controlling an output of the electric fluid pump such that the output of the pump is made larger as a temperature of the fluid is lower.

4. The electric vehicle according to claim 1,
wherein the control apparatus is configured to determine that the running state of the electric vehicle is the motor-driving requiring state when a running speed of the electric vehicle is not lower than a predetermined first speed value, and
wherein the control apparatus is configured to determine that the running state is in the transition from the motor-driving non-requiring state to the motor-driving requiring state when the running speed is lower than the predetermined first speed value and is not lower than a predetermined second speed value that is lower than the predetermined first speed value by a predetermined value.

5. The electric vehicle according to claim 1,
wherein the control apparatus is configured to determine that the running state of the electric vehicle is the motor-driving requiring state when a running speed of the electric vehicle is not higher than a predetermined third speed value, and
wherein the control apparatus is configured to determine that the running state is in the transition from the motor-driving non-requiring state to the motor-driving requiring state when the running speed is higher than the predetermined third speed value and is not higher than a predetermined fourth speed value that is higher than the predetermined third speed value by a predetermined value.

6. The electric vehicle according to claim 4,
wherein the control apparatus is configured is set the predetermined value such that the predetermined value is made larger as a temperature of the fluid is lower.

7. The electric vehicle according to claim 5,
wherein the control apparatus is configured is set the predetermined value such that the predetermined value is made larger as a temperature of the fluid is lower.

8. The electric vehicle according to claim 1,
wherein the control apparatus is configured to determine that the running state of the electric vehicle is the motor-driving requiring state when a drive request amount is not smaller than a predetermined first amount value, and
wherein the control apparatus is configured to determine that the running state is in the transition from the motor-driving non-requiring state to the motor-driving requiring state when the drive request amount is smaller than the predetermined first amount value and is not smaller than a predetermined second amount value that is smaller than the predetermined first amount value by a predetermined value.

9. The electric vehicle according to claim 1,
wherein the control apparatus is configured to determine that the running state of the electric vehicle is the motor-driving requiring state when a drive request amount is not smaller than a predetermined first amount value, and
wherein the control apparatus is configured to determine that the running state is in the transition from the motor-driving non-requiring state to the motor-driving requiring state when the electric vehicle is on an uphill road even if the drive request amount is smaller than the predetermined first amount value.

10. The electric vehicle according to claim 1,
wherein the lubrication fluid passage includes (b-4-i) an axially extending portion which extends in an axial direction of the pinion shaft and (b-4-ii) a radially extending portion which is connected to the axially extending portion and which extends in a radial direction of the pinion shaft, such that the fluid discharged from the electric fluid pump is introduced into the axially extending portion and comes out from the radially extending portion so as to be supplied to the component.
